(19) United States
(12) Patent Application Publication
(10) Pub. No.: US 2003/0177019 A1
(43) Pub. Date: Sep. 18, 2003

(54) System and method for visual representation of an electroni community

(76) Inventors: Richard A. Santos, Roseville, CA (US); Garry S. Orsolini, Fair Oaks, CA (US); Stephen A. White, Gold River, CA (US)

Correspondence Address: HEWLETT-PACKARD COMPANY, Intellectual Property Administration, P.O. Box 272400, Fort Collins, CO, 80527-2400, US

(21) Appl. No.: 10/100,470

(22) Filed: Mar. 18, 2002

(51) Int. Cl. G06F 17/60

(52) U.S. Cl. 705/1

(57) ABSTRACT

In one embodiment, the present invention is directed to a method for facilitating communication between community members. The method may comprises the steps of: defining a plurality of events to facilitate communication between community members; creating at least one graphical representation of a virtual campus including a plurality of venues, wherein each event of the plurality of events is graphically associated with one of the plurality of venues, and wherein each of the plurality of venues is representative of a type of communication utilized by its respective event; providing the at least one graphical representation to the community members; receiving selection of selected ones of the plurality of events by the community members; providing communication defined by the plurality of events to the community members; and modifying the at least one graphical representation to reflect participation of the community members in the selected ones of the plurality of events.

### TECHNICAL FIELD

The present invention is related to a system and method for visually representing an electronic community and more particularly to a system and method for visually representing utilizing a plurality of community segments associated with real time events.

### BACKGROUND OF THE INVENTION

At the present time, it is possible to access content on the Internet through any number of mechanisms. The most common mechanism includes utilizing a browser to obtain a web page through a web browser application. In general, the experience of a user retrieving content on the web is somewhat static. Specifically, the web browsing experience involves relatively little interaction. The user simply selects various hyperlinks or provides minimal search criteria to retrieve content.

However, there are more interactive opportunities on the Internet than typical websites. For example, a further feature of the Internet is the Usenet. The Usenet is a news group service that facilitates discussion groups on the Internet. Usenet discussion groups are based on the exchange of news articles, bulletins, and messages. The groups are similar to e-mail interactions, but are more efficient at delivering information to large groups of people. Articles and messages are put into a central database, and users access the database to read the information. Users may also access the database to provide information. News groups are organized into a hierarchy with top-level groups having names such as comp (computers), news, rec (recreation), sci (science), etc. The Usenet does provide a slightly more interactive approach in that it is tailored to a specific interest, subject, or the like. However, it is relatively impersonal in that it is designed to operate in association with a relatively large group of users indiscriminately.

Another feature of the Internet are communities or discussion groups. A community is a web site on the Internet associated with a common trait or common interest such as a particular topic, subject, or theme. Examples of communities may include a community directed to university students or a community directed to employees of a particular organization. Users can go to the web site and discuss or research the topic. For example, Yahoo.com has several different communities, that are organized by area of interest. For example, under the Arts & Humanities section of Yahoo.com, there are approximately twenty six different categories of communities that a user could choose to visit. For example, a user may select the Artists category under the Arts & Humanities section and the Masters subcategory under the Artists category, to view information and provide comments on Salvador Dali. If a user cannot find a particular community, the user can create a community, and place the new community in an appropriate place within the category hierarchy. Even through communities and discussion groups provide a significantly more interactive experience than other Internet resources, the capabilities of communities and discussion groups are still limited. Specifically, very little information is available regarding the background or capabilities of other members of the community or conversation group. Additionally, communities or discussion groups do not provide any type of information regarding the current state of a community member or a community event.

Another feature of the Internet is chat rooms. Chat rooms provide a forum for Internet users to communicate in real time or in substantially real time. Chat rooms provide a textually based conversational experience. A chat room may have a frame that details the chat room members. Another frame of the chat room may set forth the text comments of the chat room users to facilitate the chat room conversation. Moreover, chat rooms provide very little information pertaining to the state of the chat room or chat room members. Chat rooms merely detail who is participating in the chat room by listing various Internet pseudonyms. However, the identity and background of the users in a chat room is often unknown. In fact, one of the primary characteristics of chat rooms is the anonymous nature of the communication.

### BRIEF SUMMARY OF THE INVENTION

In one embodiment, the present invention is directed to a method for facilitating communication between community members. The method may comprises the steps of: defining a plurality of events to facilitate communication between community members; creating at least one graphical representation of a virtual campus including a plurality of venues, wherein each event of the plurality of events is graphically associated with one of the plurality of venues, and wherein each of the plurality of venues is representative of a type of communication utilized by its respective event; providing the at least one graphical representation to the community members; receiving selection of selected ones of the plurality of events by the community members; providing communication defined by the plurality of events to the community members; and modifying the at least one graphical representation to reflect participation of the community members in the selected ones of the plurality of events.

### BRIEF DESCRIPTION OF THE DRAWINGS

FIG. 1 is a computer screen of a virtual campus according to an embodiment of the present invention.

FIG. 2 is another computer screen of a virtual campus according to an embodiment of the present invention.

FIG. 3 is another computer screen of a virtual campus according to an embodiment of the present invention.

FIG. 4 is another computer screen of a virtual campus according to an embodiment of the present invention.

FIG. 5 is a block diagram of a computer system according to embodiments of the present invention.

FIG. 6 is an event record according to an embodiment of the present invention.

FIG. 7 is a user record according to an embodiment of the present invention.

FIG. 8 illustrates computer system adapted according to embodiments of the present invention.

FIG. 9 depicts a flowchart according to embodiments of the present invention.

### DETAILED DESCRIPTION OF THE INVENTION

The present invention relates to systems and methods for creating an interactive experience for Internet or other networked users. Specifically, the interactive experience involves the visual representation of an Internet or electronic community. Visual representation of a community may address various components of a community. For example, members of a community may be represented visually. Specifically, the capability, background, experience of community members may represented visually. Alternatively, the current status, activity, or state of a member may be represented visually.

Other aspects of a community may additionally or alternatively be represented visually. For example, sub-categories or sub-topics of the community may be represented visually. For example, a virtual world or hyperspace may be defined. Certain portions of the virtual world or hyperspace may correspond to specific topics or specific events. For example, a presentation of a white paper on a particular topic may be visually represented via a display of lecture hall within a community virtual world or hyperspace. Community members may receive streaming video of the presentation by selecting or clicking on a seat of the lecture hall.

Additionally, the status, desired level of interaction, or event interaction between members of a community may be represented visually. For example, certain members may be present in the community while desiring to remain passive. Specifically, members of the community may wish to observe a community event (via streaming content) and may wish to not be contacted by other members. Certain members may be engaged in a private Internet conversation and may wish to not be interrupted. Such states may be represented visually by, for example, varying the color and/or the shape of the graphical representations of community members.

Also, certain members may be seeking other members who possess a particular background, interest, or experience. Utilizing member profiles, embodiments of the present invention are capable of depicting members utilizing representations to reflect the degree that their profiles match the desired criteria. For example, a gardening community member may be actively searching for another community member who possesses knowledge of transplanting biennials. Individuals possessing experience in gardening may be depicted utilizing a predetermined color or shape.

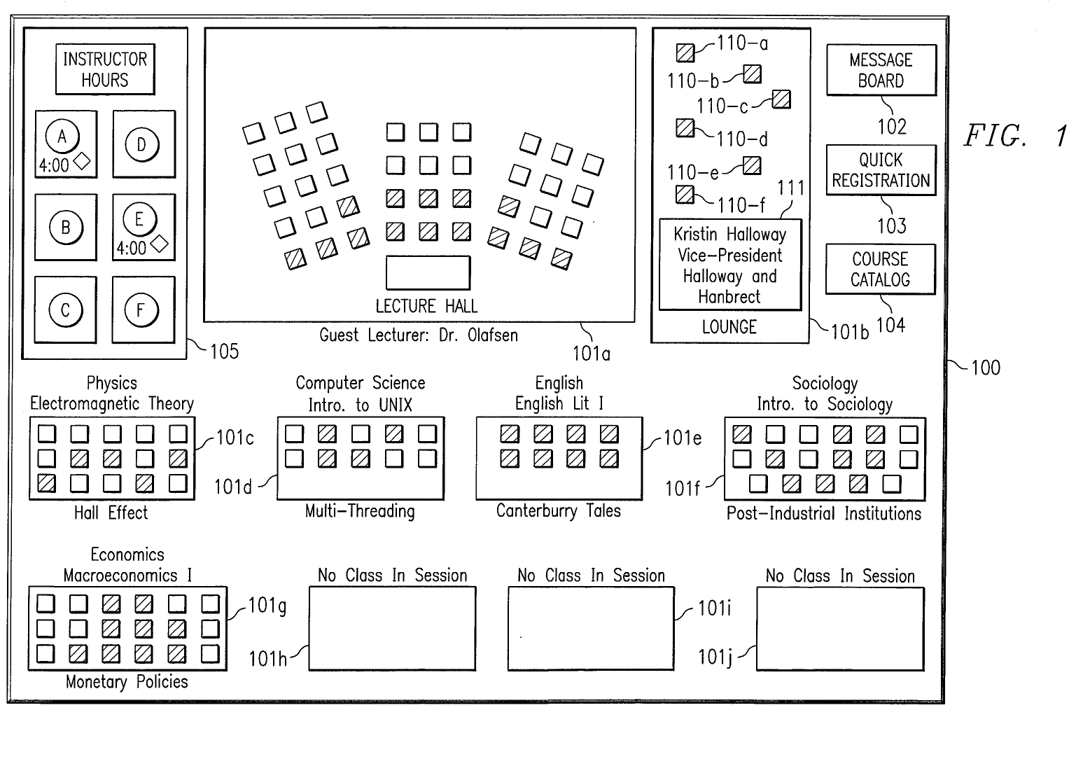

The preceding has discussed the present invention at a relatively high level. For illustrative purposes only without limiting the present invention, the present invention may be utilized to create a virtual campus as depicted in FIG. 1.

The virtual campus as depicted in FIG. 1 may be retrieved from a web server or servers that maintain the community. Screen view 100 associated with the virtual campus may preferably be viewed by community members after logging onto the community utilizing an appropriate web site identifier such as a Uniform Resource Locator (URL). Screen view 100 may be presented via an Internet application, a general purpose browser such as Microsoft Explorer of Netscape Navigator, a special purpose browser, or any other suitable application. It shall be appreciated that the same view of the campus is not necessarily presented to each community member. The view of the campus may be advantageously adapted for each community member according the member's unique characteristics, preferences, and/or the like.

Screen view 100 depicts a virtual campus or hyperspace. Screen view 100 preferably gives a community member of the virtual campus a real time or near real time connection to the virtual campus. Specifically, screen view 100 depicts a plurality of community segments (101a-101i) and some of the community segments are associated with real time events of the virtual campus.

Screen view 100 preferably designates or separates real time events in a manner that is intuitive to users. Real time events refer to applications or processes that facilitate communication with a number of members on a substantially real time basis. For example, a real time event may comprise distribution of streaming video to a plurality of community members. Another real time event may comprise a community discussion group in which community members may communicate via text messaging.

It shall be appreciated that events associated with the community are not merely presented as a list or static textual display of messages. Instead, real time events may be advantageously separated into “physical locations” of the virtual campus via community segments. The locations of the virtual campus preferably include various venues such as lecture hall 101a, lounge 101b, and classrooms 101c-101j. Other-venues may be included such as offices, conference rooms, libraries, and/or the like. The various locations or venues may be associated with a real time event. Preferably, venues are selected according to the type of communication that will occur with the real time or substantially real time event. For example, lecture hall 101a may be selected for events using one-way communication (e.g., streaming video for a lecture). Classrooms 101c-101j may be selected for events using limited two-way communication. Lounge 101b may be selected for events using unstructured two-way communication. Offices (not shown) may be selected for private communications.

For example, the real time event associated with lecture hall 101a is shown to be “Guest Lecturer: Dr. Olafsen.” Lecture hall 101a depicts a number of seats available to participants in the event. The number of seats may be limited, for example, by the capacity of a web server to stream video to a particular number of participants. Certain seats are shown to be occupied. Other seats are shown to be unoccupied to indicate that other participants may join the real time event. A participant may join the lecture event by clicking on an empty seat. In response, this may cause the user's browser to receive streaming video of Dr. Olafsen's presentation. If desired, selected seats may be reserved for particular participants, while other seats may be “open” for general admission.

As another example, various classes associated with the virtual campus may occur online. Classrooms 101c-101j may be depicted with class descriptions and lecture topics. The “Electromagnetic Theory” class is shown to be discussing the Hall Effect in classroom 101c. The “Introduction to Unix” class is shown to be discussing Multi-Threading in classroom 101d. The “English Literature” class is shown to be discussing Canteburry Tales in classroom 101e. The “Introduction to Sociology” class is shown to be discussing Post-Industrial Institutions in classroom 101f. The “Macroeconomics” class is shown to be discussing Monetary Policies in classroom 101g. Classrooms 101h-101j are shown to be temporarily unoccupied.

The depiction of the classes may include the number of students in the various classrooms. For example, seats in classroom 101c-101j may change color when a student occupies the respective seat. Attendance of classes may be monitored by recording when various students enter the lectures by clicking on the various seats of classrooms 101c-101j. Moreover, the instructor may utilize the graphical representations to determine the identity of students to facilitate interaction between the instructor and the students. Interaction may occur, for example, by sending stream video of the instructor and allowing students to submit questions via text-messaging. In this manner, community members may associate a sense of belonging or connectivity to a set of real time events or activities.

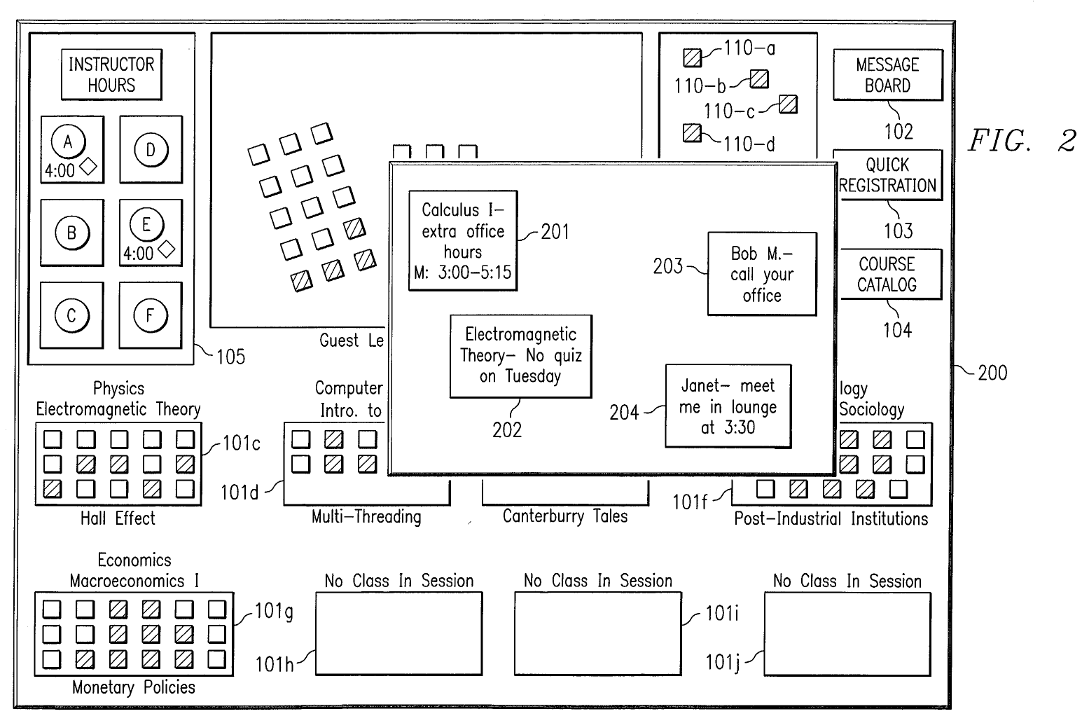

Communication may also occur in the virtual campus in an asynchronous manner. For example, a student may click on message board 102. In response, the student's browser may receive information to display computer screen 200 of FIG. 2. Asynchronous messages 201-204 may be left for groups of students or for particular individuals. For example, message 201 is intended for students enrolled in Calculus I, while message 204 is intended for a specific individual.

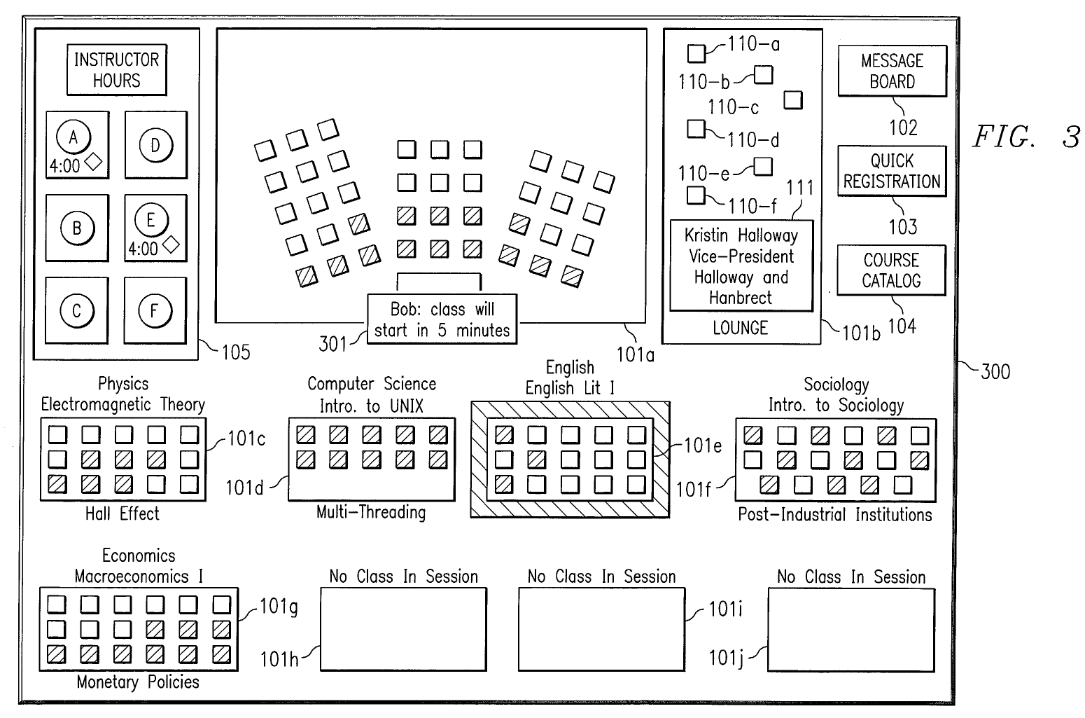

The virtual campus may provide notice of real time events to users. For example, schedule icon 105 provides instructor hour information to users in a relatively static manner. Schedule icon 105 may allow students to determine when a particular instructor will be available to discuss class-related issues. Also, the virtual campus may dynamically provide notice of real time events. For example, turning now to FIG. 3, screen 300 provides alarm message 301. Alarm message 301 communicates to student “Bob” that his class will begin in five minutes. Additionally, the representation of particular classroom for the class may be modified to indicate that the particular real time event will take place in a short period of time. For example, the depiction of the respective classroom may flash or change colors. Similar notification of real time events may occur utilizing a community member's personal profile. If the community member's personal profile indicates that the community member is interested in Molecular Biology, the representation of the virtual campus may highlight lecture hall 101a when a lecture concerning this topic is taking place.

Communication may also occur in a less structured environment. For example, the virtual campus includes lounge 101b. Lounge 101b is shown to include students 110-a through 110-f. Lounge 101b may provide a campus location where students or other participants may gather when the students or participants are interested in being engaged in real time communication. For example, student 110-a may be expecting to “meet” a classmate in lounge 101b to discuss a class project. Additionally, it is advantageous to allow a user to determine the identity of the students. For example, a user may select or click on student 110-f and, in response, dialog box 111 may be provided to the user to detail the identity of student 110-f and other pertinent details. The pertinent details may include any type of relevant information. For example, a business card template may be utilized for provide identity information if appropriate for a particular application.

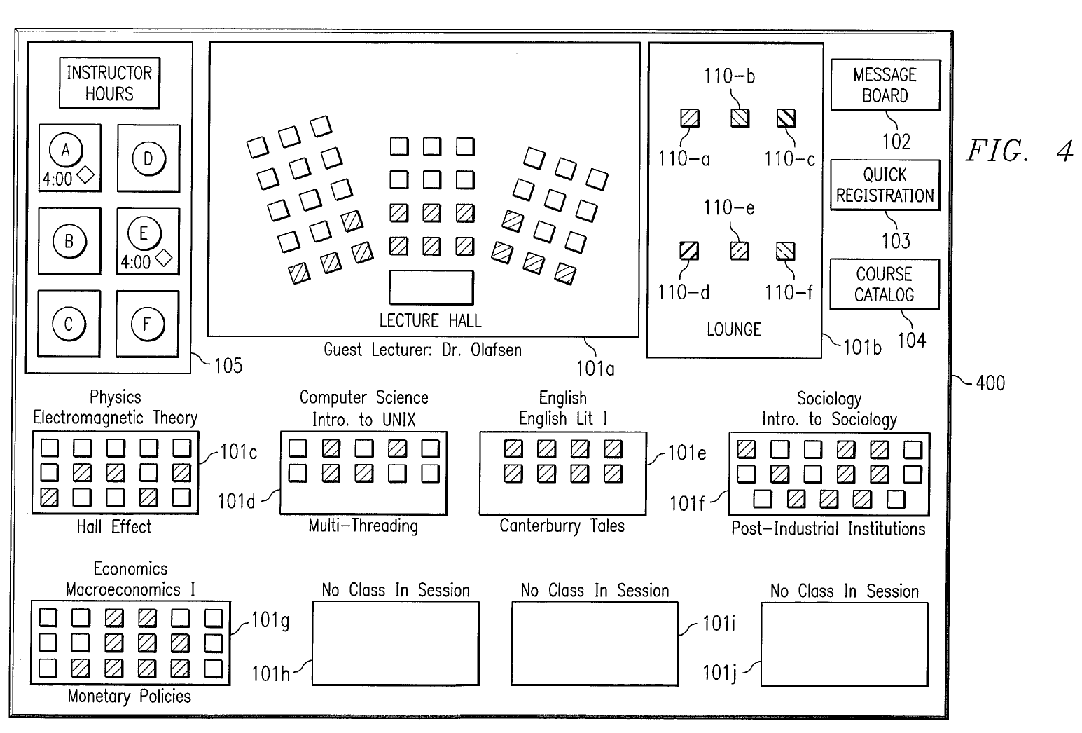

Referring now to FIG. 4, embodiments of the present invention may facilitate communication between users by identifying users which possess similar or corresponding states. For example, a user may be interested in communicating with a student who possesses appreciable knowledge of Vector Calculus. The user may enter this information into an appropriate data control when the user accesses the virtual campus. As depicted in lounge 101b of screen 400 of FIG. 4, this may cause students who possess such knowledge to be represented by a particular visual state (e.g, the students representations matching the information or criteria may be rendered utilizing a red hue as represented by students 110-c and 110-d). Other students may be represented by a different state (e.g., the other student representations may be rendered utilizing a green hue as represented by student 110-e). By representing members of the virtual campus or community in this manner, individuals may quickly identify the background of other individuals. Individuals seeking advice or information and individuals capable of providing advice or information may easily locate each other.

Returning to FIG. 1, students may interact with automated features. For example, screen 100 includes registration icon 103. By clicking on registration icon 103, a student may input various class information into a database application to register for an upcoming semester. Additionally, students may retrieve static information via the virtual campus. For example, a student may obtain class descriptions, class hours, and/or the like by selecting course catalog icon 104.

In embodiments of the present invention, the views of the virtual campus are preferably updated in a substantially real time basis. For example, a browser application may be set to refresh its view on a periodic basis to obtain new information. Alternatively, certain components (e.g., an HTML frame) may receive streaming data to display updated information.

It shall be appreciated that the present invention is applicable to any number of potential applications. For example, the present invention may be utilized to organize a virtual corporate campus. By creating a virtual corporate campus, employees may be located in geographically disparate locations. Real time events may be depicted such as a conference meeting or a project discussion as examples. The status of employees may be presented in a dynamic manner. For example, a particular employee may be depicted as being present but unavailable due to a scheduled interview. Employees may be supervised in a real time manner by examining their presence at virtual locations and participation in various events. Additionally, employees may maintain real time interaction to facilitate collaboration on various corporate projects.

FIG. 5 depicts a block diagram of system 500 which maintains a virtual campus or hyperspace to facilitate communication between community members. System 500 includes campus webserver 501. Campus webserver 501 communicates with user devices 502-1 through 502-N. For example, a user may access the virtual campus via the user's browser which initiates hypertext transfer protocol (HTTP) transactions with campus webserver 501. A user may communicate a request to enter or view the virtual campus via an HTTP transaction. Campus webserver 501 may communicate HyperText Markup Language (HTML files) to user devices 502-1 through 502-N via the HTTP transactions. The HTML files may contain views of the hyperspace or campus. The HTML files may contain representations of the various other users or community members.

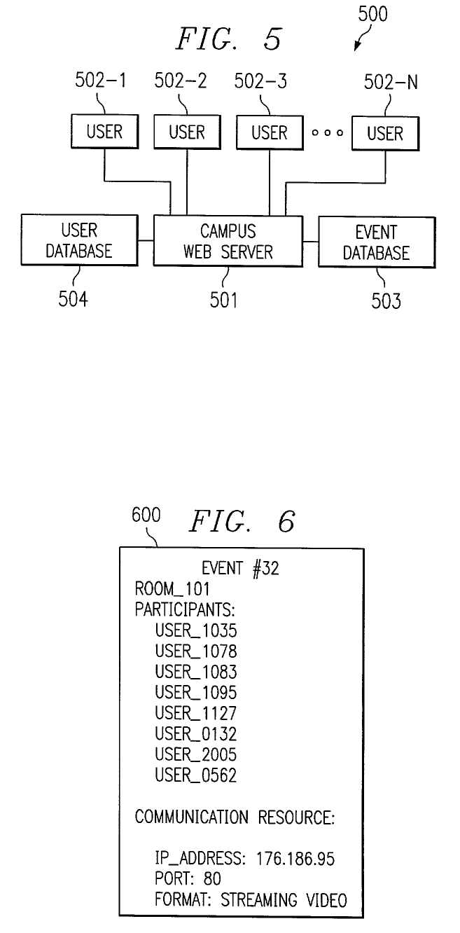

Campus webserver 501 may construct such HTML files utilizing records stored in user database 504 and event database 503. For example, event database 503 may comprise a plurality of event records such as event record 600 of FIG. 6. Event record 600 may include a number of fields. Event record 600 may include a field to identify the location within the virtual campus or hyperworld associated with its real time event. Event record 600 may include fields identifying the users or participants in the respective real time event.

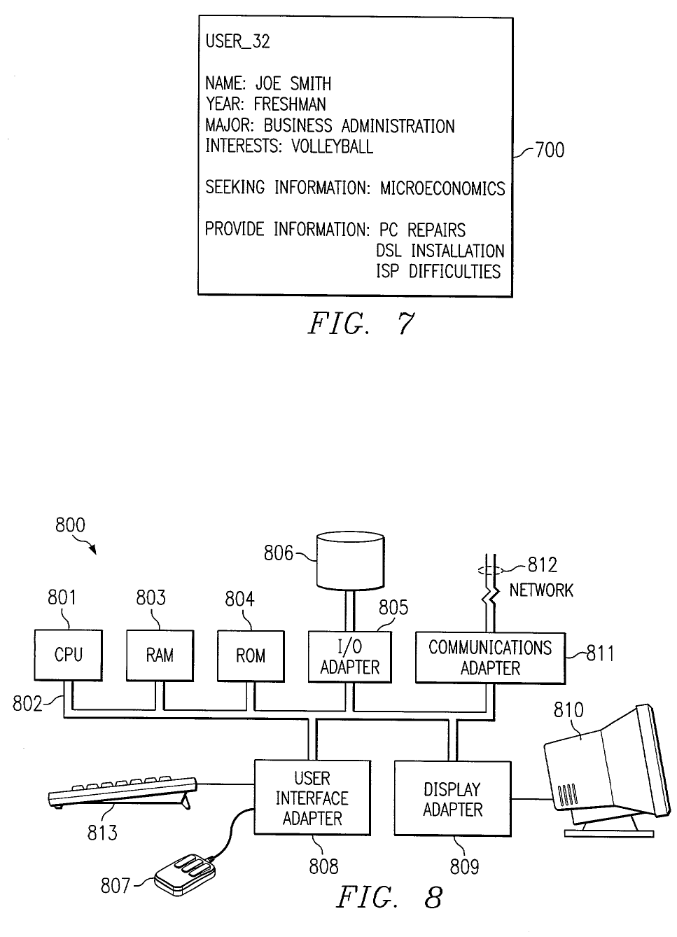

Utilizing the fields of event record 600, campus webserver 501 may host real time events by controlling access or participation in the events. Specifically, a user may attempt to join a real time event by selecting or clicking on an icon of the virtual campus. Campus webserver 501 may access event record 600 to determine if additional participants are permitted. Moreover, campus webserver 501 may access a student profile stored in student record 700 as will be discussed with respect to FIG. 7 to determine whether the user is authorized to participate.

If the access or participation is permitted, campus webserver 501 may utilize a communication resource field of event record 600. The communication resource may be associated with campus webserver 501. Alternatively, the communication resource may be associated with another platform. The communication resource field may specify the Internet Protocol (IP) address of the communication resource. The communication resource field may further specify the port of the communication resource. The communication resource field may further specify the type of communication (e.g., streaming video). Campus webserver 501 may construct HTML files that will cause the user's browser to facilitate the desired communication. For example, the HTML files may comprise a frame(i.e. a frame that is distinct from a frame associated with a view of the virtual campus) to facilitate the communications. The separate frame may include an appropriate tag or tags to retrieve the streaming video or other communication data from the identified resource. Alternatively and/or additionally, the tag or tags may facilitate text messaging between participants to facilitate participation in the real time event via the communication resource.

Campus webserver 501 may access user database 504 to obtain student records, such as student record 700 of FIG. 7, to construct the various HTML files. Student record 700 may include various information to construct a student profile. Student record 700 preferably includes various student identification information such as student name, student year, major, and interests as examples. Student record 700 may further include a field that identifies desired characteristics of other students. The characteristics may be used to identify other students that the particular student may wish to contact. For example, the student may be seeking other students who are familiar with Microeconomics. Also, student record 700 may include fields that specify the student's area of expertise, such as PC repair, DSL installation, ISP difficulties as examples for this particular student. Campus webserver 501 may utilize the various fields to identify other students to this student or identify this student to other students.

When implemented via executable instructions, various elements of the present invention are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 8 illustrates computer system 800 adapted according to embodiments of the present invention. Central processing unit (CPU) 801 is coupled to system bus 802. CPU 801 may be any general purpose CPU. Suitable processors, without limitation, include any processor from the Itanium® family of processors or an PA-8500 processor available from Hewlett-Packard Company. However, the present invention is not restricted by the architecture of CPU 801 as long as CPU 801 supports the inventive operations as described herein.

CPU 801, by executing appropriate instructions, may generate HTML files or other files that can be utilized to depict computer screens 100-400. CPU 801 may, by executing appropriate instructions, generate depictions of other community members to facilitate communication. For example, CPU 801 may depicts certain members according to determined colors to identify members possessing a particular background, interest, experience, and/or the like.

Computer system 800 also includes random access memory (RAM) 803, such as SRAM, DRAM, SDRAM, or the like. Computer system 800 includes ROM 804 which may be PROM, EPROM, EEPROM, or the like. RAM 803 and ROM 804 hold user and system data and programs as is well known in the art.

Computer system 800 also includes input/output (I/O) adapter 805, communications adapter 811, user interface adapter 808, and display adapter 809. I/O adapter 805 connects to storage devices 806, such as one or more of hard drive, CD drive, floppy disk drive, tape drive, to computer system 800. Storage devices 806 may retain databases to construct the HTML files of the virtual campus such as event database 503 and user database 504. Communications adapter 811 is adapted to couple computer system 800 to network 812, which may be one or more of telephone network, local (LAN) and/or wide-area (WAN) network, Ethernet network, and/or Internet network. User interface adapter 808 couples user input devices, such as keyboard 813 and pointing device 807, to computer system 800. Display adapter 809 is driven by CPU 801 to control the display on display device 810.

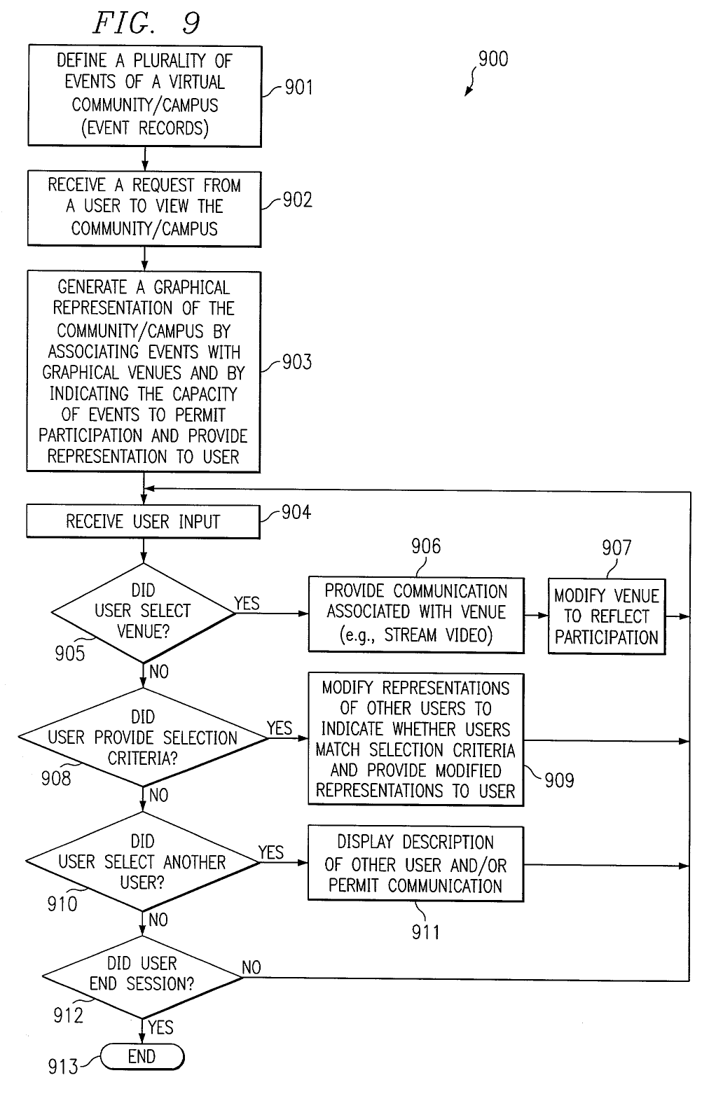

FIG. 9 depicts flowchart 900 to illustrate presentation of community events and community communication according to embodiments of the present invention. In step 901, a plurality of events of a virtual community/campus are defined. For example, an administrator may create a suitable plurality of event records 600 to define the respective events.

In step 902, a request to view the community/campus is received from a user. The request may be received according to any suitable protocol such as HTTP. In response to the request, a graphical representation of the community/campus is generated (step 903). The graphical representation may associate events with graphical venues and may indicate the capacity of events to permit participation.

In step 904, user input may be received to facilitate user interaction within the community/campus. For example, a logical comparison may be made in step 905 to determine whether the user selected a venue. If so, communication associated with the venue may be provided to the user (e.g., video may be streamed to the user) in step 906 and the representation of the venue may be modified to reflect participation by the user in step 907. The process flow may then return to step 904 to receive further user input. The generated representation is provided to the user.

If the user did not select a venue, a logical comparison may be made in step 908 to determine whether the user provided selection criteria to identify other users that match the selection criteria. If so, the representations of other users are modified to reflect whether the users match the selection criteria (step 909). For example, the representations of the other users may be modified by causing users that match the criteria to be displayed with a first color and/or shape and by causing users that do not match the criteria to be displayed with a different color and/or shape. The process flow may then return to step 904 to receive further user input.

If the user did not provide selection criteria, a logical comparison may be made to determine whether the user selected another user (step 910). If so, the description of the other user may be displayed and/or communication between the user and the other user may be permitted. The process flow may then return to step 904 to receive further user input.

If the user did not select another user, a logical comparison may be made to determine whether the user provided input to end the session (step 912). If so, the process flow may end (step 913). If not, the process flow may then return to step 904 to receive further user input. It shall be appreciated that the preceding steps are merely. Any number of additional and/or alternative steps may be included to implement various community activities according to embodiments of the present invention.

Embodiments of the present invention provide numerous advantages. First, embodiments of the present invention provide a sense of belonging or connectivity to community members by representing community member communication in a manner that is intuitive to users. Specifically, real time events of a community may be represented spatially via community segments. Secondly, embodiments of the present invention provide navigation advantages. Community members are able to quickly determine the content of real time events associated with the community or virtual campus. Community members may join or participate in the real time event with little appreciable difficulty. Moreover, embodiments of the present invention allow community members to quickly identify other members by representing community members according to various criteria. The criteria may include any type of background, interests, or experience information. By utilizing such criteria to alter the visual representation of community members, efficient communication between community members is greatly enhanced.

1. A method for facilitating communication between community members, comprising:
defining a plurality of events to facilitate communication between community members;
creating at least one graphical representation of a virtual campus including a plurality of venues, wherein each event of said plurality of events is graphically associated with one of said plurality of venues, and wherein each of said plurality of venues is representative of a type of communication utilized by its respective event;
providing said at least one graphical representation to said community members;
receiving selection of selected ones of said plurality of events by said community members;
providing communication defined by said plurality of events to said community members; and
modifying said at least one graphical representation to reflect participation of said community members in said selected ones of said plurality of events.

2. The method of claim 1, wherein said at least one graphical representation includes representations of said community members, said method further comprising the steps of:
receiving a selection of a first community member by a second community member; and
providing a description of said first community member to said second community member.

3. The method of claim 1 wherein said at least one graphical representation includes representations of said community members, said method further comprising the steps of:
receiving selection criteria identifying at least one desired characteristic from at least one community member;
modifying representations of said community members with information indicative of whether community members match said at least one desired characteristic; and
providing said at least one graphical representation including said modified representations of community members to said at least one community member.

4. The method of claim 3 wherein said step of modifying representations includes representing community members matching said at least one desired characteristic with a first color and representing community members not matching said at least one desired characteristic with a second color.

5. The method of claim 1 wherein said step of providing communication includes providing streaming video of an event of said plurality of events.

6. The method of claim 1 wherein said step of creating at least one graphical representation includes providing information indicative of a capacity of an event of said plurality of events to accept participation by an additional community member of said plurality of community members.

7. The method of claim 1 wherein said step of defining a plurality of events includes creating a plurality of event records.

8. The method of claim 7 wherein each of said plurality of event records identifies a communication resource that provides communication associated with its respective event.

9. A computer readable medium comprising executable instructions to facilitate communication between community members, said computer readable medium comprising:
code for creating at least one graphical representation of a campus, said campus including a plurality of venues associated with occurring events;
code for providing said at least one graphical representation to said community members;
code for receiving selections of ones of said plurality of venues by said community members;
code for modifying said at least one graphical representation to indicate participation in said ones of occurring events; and
code for permitting access by said community members to communication associated with said ones of occurring events.

10. The computer readable medium of claim 9, wherein said at least one graphical representation includes representations of said community members, and said computer readable medium further comprising:
code for receiving a selection of a first community member by a second community member; and
code for providing said at least one graphical representation including a description of said first community member to said second community member.

11. The computer readable medium of claim 9 wherein said at least one graphical representation includes representations of said community members, and said computer readable medium further comprising:
code for receiving a selection criteria identifying a desired characteristic;
code for modifying representations of said community members with information indicative of whether community members match said at least one desired characteristic; and
code for providing said at least one graphical representation including said modified representations of community members to said at least one community member.

12. The computer readable medium of claim 11, wherein said code for modifying representations includes represents community members matching said at least one desired characteristic with a first color and represents community members not matching said at least one desired characteristic with a second color.

13. The computer readable medium of claim 9 wherein said code for permitting access includes code for providing a file comprising a frame to receive streaming video.

14. The computer readable medium of claim 9 wherein said venues of said campus reflect a format of communication associated with its respective event.

15. The computer readable medium of claim 9 wherein said code for creating at least one graphical representation depicts each of said plurality of venues to indicate capacity of an event associated with each respective venue to accept participation by an additional community member.

16. A method for facilitating communication between community members, comprising:
receiving a request from a community member to view a virtual campus;
generating at least one graphical representation of a virtual campus including a plurality of venues, wherein each event of a plurality of events is graphically associated with one of said plurality of venues, and wherein each of said plurality of venues is representative of a type of communication utilized by its respective event;
providing said at least one graphical representation to said community member;
receiving a selection of a selected event of said plurality of events by said community member;
providing communication defined by said selected event to said community members; and
modifying said at least one graphical representation to reflect participation of said community member in said selected event.

17. The method of claim 16, wherein said at least one graphical representation includes representations of other community members, said method further comprising the steps of:
receiving a selection of a selected community member by said community member; and
providing a description of said selected community member to said community member.

18. The method of claim 16 wherein said at least one graphical representation includes representations of other community members, said method further comprising the steps of:
receiving selection criteria identifying at least one desired characteristic from said community member;
modifying representations of said other community members with information indicative of whether said other community members match said at least one desired characteristic; and
providing said at least one graphical representation including said modified representations of said other community members to said community member.

19. The method of claim 18 wherein said step of modifying representations includes representing said other community members matching said at least one desired characteristic with a first color and representing said other community members not matching said at least one desired characteristic with a second color.

20. The method of claim 16 wherein said step of providing communication comprises streaming video information to said community member.
